(19) United States
(12) Patent Application Publication
(10) Pub. No.: US 2011/0249116 A1
(43) Pub. Date: Oct. 13, 2011

(54) COLOR MEASURING APPARATUS AND COLOR MEASURING METHOD

(75) Inventor: Eiichi YAMAGISHI, Shiojiri (JP)

(73) Assignee: SEIKO EPSON CORPORATION, Tokyo (JP)

(21) Appl. No.: 13/081,602

(22) Filed: Apr. 7, 2011

(30) Foreign Application Priority Data
Apr. 9, 2010 (JP) 2010-090160

(51) Int. Cl. H04N 7/18

(52) U.S. Cl. 348/135; 348/E07.085

(57) ABSTRACT

A color measuring apparatus includes an image taking section; a signal generating section selecting a teach image in which a plurality of measurement regions are set or a measurement image for color measurement and making a display device display the selected image; a camera control section controlling the image taking section to make the image taking section take an image of the image displayed on the display device; a measurement region recognizing section recognizing the measurement regions by performing image processing on the teach image whose image was taken by the image taking section; and a color measuring section measuring the color of each of measured regions corresponding to the measurement regions recognized by the measurement region recognizing section, the measured regions in the measurement image whose image was taken by the image taking section.

### BACKGROUND

1. Technical Field

The present invention relates to a color measuring apparatus and a color measuring method.

2. Related Art

In the past, a color measuring apparatus provided with an RGB filter-equipped single-chip or three-chip color camera and an arithmetic unit which corrects the measurement value obtained by the camera has been used in order to inspect the quality of a display image of an image display device (JP-A-6-233333 (hereinafter referred to as Patent Document 1)).

Moreover, a color measuring apparatus provided with a color camera with sequential tristimulus filters and a control apparatus which calculates the chromaticity by combining the image data of the tristimulus values has been known (JP-A-6-201472 (hereinafter referred to as Patent Document 2)). The tristimulus filters described in Patent Document 2 are each set in a circular folder and sequentially face a light receiving element as a result of the rotation of the folder.

In recent years, the uses of the display device have changed from the existing text display to display of a natural image or a graphic image, and a more colorful image has often been projected. On the other hand, the intensity of a projector has become so high that the projector can be used in any location, and the optical energy density of the projector has increasingly become high. This causes optical strains in a lamp serving as a light source, an electrooptic transducer, or an internal optical component, leading to a reduction of color uniform performance. It is against this background that measuring the color uniform performance with high accuracy and at high speed has become necessary for developing and producing a display device with high color uniformity.

For measurement of the color uniform performance, the need to perform measurement of color at multiple points in a screen with ease is growing in a quality inspection of a display device.

Incidentally, Patent Documents 1 and 2 do not describe multipoint measurement in a screen. In the past, in a measuring device performing multipoint measurement, a measurer has set and input a measurement location one by one by input operation using a mouse. At this time, a user who desires to improve the accuracy of multipoint measurement sometimes sets and inputs hundreds of measurement locations, and it undesirably takes an immense amount of time to perform setting operation for measurement. Moreover, it is very complicated to set a measurement location by input operation using a mouse without impairing accuracy. Furthermore, it is more complicated and takes more time to set a deformed region, such as a circular or oval region, other than a rectangular region accurately. As described above, with the existing measuring method, it undesirably takes an immense amount of time to perform setting operation for measurement.

### SUMMARY

An advantage of some aspects of the invention is to provide a color measuring apparatus and a color measuring method which can set a measurement region for multipoint measurement with ease and in a short time.

According to an aspect of the invention, there is provided a color measuring apparatus including: an image taking section taking an image of an image displayed on a display device; an image display control section selecting a teach image in which a plurality of measurement regions are set or a measurement image for color measurement and making the display device display the selected image; a camera control section controlling the image taking section to make the image taking section take an image of the image displayed on the display device; a measurement region recognizing section recognizing the measurement regions by performing image processing on the teach image whose image was taken by the image taking section; and a color measuring section measuring the color of each of measured regions corresponding to the measurement regions recognized by the measurement region recognizing section, the measured regions in the measurement image whose image was taken by the image taking section, wherein, in the teach image, the plurality of measurement regions are shown with a certain degree of chromaticity or brightness and non-measurement regions other than the measurement regions are shown with a different degree of chromaticity or brightness, and the measurement region recognizing section recognizes the measurement regions by performing image processing on the teach image whose image was taken by the image taking section based on the difference in degree of chromaticity or brightness between the measurement regions and the non-measurement regions.

According to the aspect of the invention, a teach image in which a plurality of measurement regions are shown with a certain degree of chromaticity or brightness and non-measurement regions other than the measurement regions are shown with a different degree of chromaticity or brightness is displayed on the display device, an image of the teach image is taken, and the measurement regions are recognized by performing image processing by using the fact that at least one of the chromaticity and brightness of the measurement regions of the teach image is different from that of the non-measurement regions. For example, when the brightness of the measurement regions in the teach image is higher than the brightness of a region to be measured, a threshold value for sorting these regions based on whether or not the brightness of a region is higher than the threshold value is used, and only regions with a brightness which is higher than the threshold value are extracted. In this way, the measurement regions can be recognized.

Then, a measurement image is displayed on the display device, an image of the measurement image is taken, and the color of each of measured regions corresponding to the recognized measurement regions, the measured regions in the taken measurement image, is measured.

By doing so, a measured region in which the color is measured, the measured region in the measurement image, is automatically set by image processing by which the measurement regions in the teach image are recognized. This makes it possible to eliminate the need for input operation performed by the user to set a measured region by using a mouse or the like. Therefore, it is possible to set a large number of measured regions in a measurement image displayed on the display device with ease, and set measured regions for multipoint measurement with a high degree of accuracy and in a short time.

According to the aspect of the invention, it is preferable that the image taking section include three cameras which take images of the image displayed on the display device and three tristimulus filters provided in the three cameras, the tristimulus filters provided one for each of the three cameras, the camera control section perform control such that images of the image displayed on the display device are taken by the cameras concurrently, the measurement region recognizing section recognize the measurement regions by performing image processing on the images of the teach image, the images taken by the cameras, and the color measuring section measure the colors of measured regions corresponding to the measurement regions recognized by the measurement region recognizing section, the measured regions in measurement images whose images were taken by the cameras.

According to the aspect of the invention, images are taken concurrently by three cameras with three tristimulus filters, which are provided one for each of the three cameras. This eliminates the need to perform image scan operations sequentially in individual display colors, and makes it possible to shorten the amount of time. Furthermore, it is possible to prevent an increase in measuring time as a result of measurement being performed in individual display colors for one second or more in order to prevent the influence of flicker. As described above, since three tristimulus filters are provided, one for each of the three cameras, an inexpensive monochrome camera can be used also in color measurement, and it is also possible to shorten the measuring time.

Moreover, according to the aspect of the invention, it is preferable that the color measuring apparatus further include a color calibrated value calculating section calculating a color calibrated value based on a measurement value of the color of each measured region, the measurement value of the color measured by the color measuring section, and a color reference value obtained by measuring each measured region of the measurement image by a reference colorimeter; and a color corrected value calculating section calculating a color corrected value by correcting the measurement value measured by the color measuring section based on the color calibrated value calculated by the color calibrated value calculating section.

According to the aspect of the invention, the color calibrated value calculating section calculates a color calibrated value based on a measurement value measured by the color measuring section and a color reference value measured by a reference colorimeter. The color corrected value calculating section calculates a color corrected value by correcting the measurement value obtained by the color measuring section based on the color calibrated value.

Incidentally, since the reference colorimeter is used for calibration of the color measuring section, it is necessary simply to use the reference colorimeter at the start of measurement, and there is no need to use the reference colorimeter after the color calibrated value is obtained. Therefore, it is also possible to use a reference colorimeter, such as a spectroscopic color luminance meter, which can perform measurement with a high degree of accuracy, but requires a long measuring time. By obtaining a color calibrated value by using such a reference colorimeter, it is possible to correct the value measured by the color measuring section based on the measurement value obtained by the reference colorimeter, and obtain a more accurate color measurement value based on the color corrected value obtained by the correction.

According to another aspect of the invention, there is provided a color measuring method including: a teach image display controlling process in which a teach image is displayed on a display device, the teach image including a plurality of measurement regions shown with a certain degree of chromaticity or brightness and non-measurement regions shown with a different degree of chromaticity or brightness; a teach image taking process in which a taken teach image is obtained by taking, by an image taking section, an image of the teach image displayed on the display device in the teach image display controlling process; a measurement region recognizing process in which the measurement regions are recognized by performing image processing on the taken teach image obtained in the teach image taking process based on the difference in degree of chromaticity or brightness between the measurement regions and the non-measurement regions; a measurement image displaying process in which a measurement image is displayed on the display device; a measurement image taking process in which a taken measurement image is obtained by taking an image of the measurement image by the image taking section, the measurement image displayed in the measurement image displaying process; and a color measuring process in which the color of each of measured regions corresponding to the measurement regions recognized in the measurement region recognizing process, the measured regions in the taken measurement image obtained in the measurement image taking process.

According to this aspect of the invention, the same effects as those of the color measuring apparatus according to the above-described aspect of the invention can be obtained.

That is, a teach image having measurement regions and non-measurement regions is displayed on the display device in the teach image display controlling process, and an image of the teach image is taken in the teach image taking process. By performing the measurement region recognizing process in which image processing is performed on the taken teach image based on the difference in degree of chromaticity or brightness between the measurement regions and the non-measurement regions, the measurement regions are recognized. Then, in the measurement image displaying process, a measurement image is displayed on the display device, an image of the measurement image is taken in the measurement image taking process, and the color of each of measured regions corresponding to the recognized measurement regions, the measured regions in the taken measurement image, is measured in the color measuring process.

This eliminates the need for input operation performed by the user to set a measured region in which the color is measured, the measured region in the measurement image, and makes it possible to set a large number of measured regions in a measurement image displayed on the display device with ease, and set measured regions for multipoint measurement with a high degree of accuracy and in a short time.

### BRIEF DESCRIPTION OF THE DRAWINGS

The invention will be described with reference to the accompanying drawings, wherein like numbers reference like elements.

FIG. 1 is a block diagram showing a schematic configuration of a color measuring apparatus according to an embodiment of the invention.

FIG. 2 schematically shows a teach image in the embodiment.

FIG. 3 schematically shows a teach image taken by a monochrome camera provided with an X filter in the embodiment.

FIG. 4 schematically shows a teach image taken by a monochrome camera provided with a Y filter in the embodiment.

FIG. 5 schematically shows a teach image taken by a monochrome camera provided with a Z filter in the embodiment.

FIG. 6 is a flowchart showing the operation for setting a measurement region for color measurement in the embodiment.

FIG. 7 is a flowchart showing the operation for performing color measurement/correction processing in the embodiment.

FIG. 8 schematically shows a teach image according to a modified example of the invention.

FIG. 9 schematically shows a teach image according to another modified example of the invention.

### DESCRIPTION OF EXEMPLARY EMBODIMENTS

Hereinafter, an embodiment of the invention will be described based on the drawings.

### Configuration of Color Measuring Apparatus

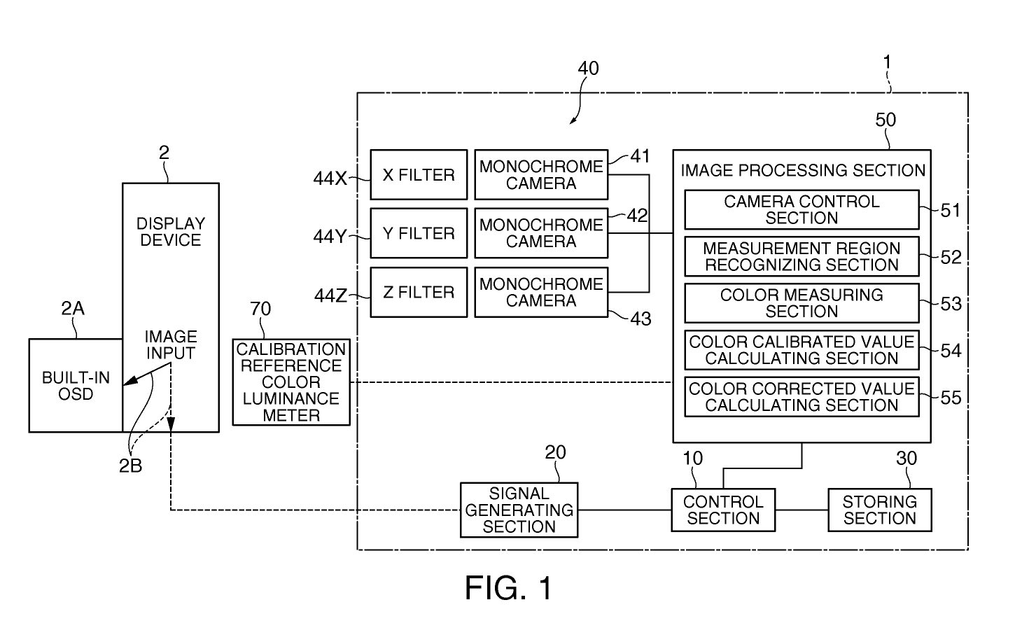

As shown in FIG. 1, a color measuring apparatus 1 is an apparatus having a color measuring function of measuring the color of an image at multiple points, the image displayed on a display device 2 which is an object to be inspected.

The color measuring apparatus 1 includes a control section 10, a signal generating section 20 serving as an image display control section which generates a signal making the display device 2 display a predetermined image, a storing section 30, an image taking section 40 taking an image of the image displayed on the display device 2, and an image processing section 50 performing image processing on the taken image.

The control section 10 controls the signal generating section 20, the storing section 30, and the image processing section 50. That is, the control section 10 performs processing for measuring the color of a display screen of the display device 2 at multiple points (in multiple regions). Moreover, the control section 10 performs an evaluation of the color uniformity of the display device 2 based on the colors (measurement values) measured at multiple points. It is for this reason that the control section 10 appropriately outputs a control signal to the signal generating section 20, the storing section 30, and the image processing section 50, and thereby controls the operation of the entire color measuring apparatus 1.

The signal generating section 20 generates a signal for making the display device 2 display an image such as a measurement image for measurement and a teach image. Specifically, the signal generating section 20 generates a display control signal for making the display device 2 display an image based on the control signal output from the control section 10, and transmits the display control signal to the display device 2, thereby making the display device 2 display a teach image or a measurement image.

Incidentally, as shown in FIG. 1, the display device 2 may have a switching section 2B which switches a state between a state in which a teach image or a measurement image is displayed according to a display control signal from the signal generating section 20 and a state in which a teach image or a measurement image is displayed according to a display control signal from a built-in OSD (on-screen display) 2A serving as a signal generating section.

The storing section 30 stores various types of program products for controlling the color measuring apparatus 1, data on a teach image and a measurement image which the display device 2 displays, and the like.

The image taking section 40 includes three monochrome cameras 41, 42, and 43. In the monochrome cameras 41 to 43, an X filter 44X, a Y filter 44Y, and a Z filter 44Z which are three tristimulus filters are respectively provided.

The monochrome cameras 41 to 43 are connected to the image processing section 50 and are controlled thereby.

The image processing section 50 controls the image taking section 40 and processes the image taken by the image taking section 40.

The image processing section 50 has a camera control section 51, a measurement region recognizing section 52, a color measuring section 53, a color calibrated value calculating section 54, and a color corrected value calculating section 55.

The camera control section 51 controls the monochrome cameras 41 to 43, makes the monochrome cameras 41 to 43 each take an image of the image displayed on the display device 2, and obtains the taken image data from the monochrome cameras 41 to 43. Incidentally, the camera control section 51 makes the three monochrome cameras 41 to 43 take the images concurrently by synchronizing the monochrome cameras 41 to 43.

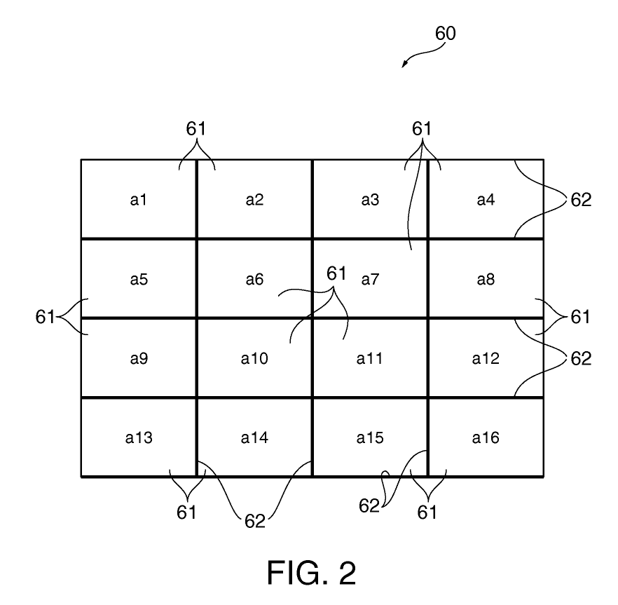

The measurement region recognizing section 52 makes the monochrome cameras 41 to 43 of the image taking section 40 each take an image of a teach image 60 displayed on the display device 2, the teach image 60 shown in FIG. 2, and performs image processing on the taken teach images individually.

Here, the teach image 60 has a plurality of white and bright measurement regions 61, for example, in this embodiment, 16 white and bright measurement regions 61, and black and dark non-measurement regions 62 which serve as grid-like partitions of the 16 measurement regions 61. Incidentally, in FIG. 2, for convenience of description, identification numbers a1 to a16 for identifying the measurement regions 61 are assigned to the measurement regions 61.

An example of the image processing performed in the measurement region recognizing section 52 is binarization by which the brightness data of the image obtained by each of the monochrome cameras 41 to 43 is compared with a predetermined threshold value, and the image is converted into a binary image in which, for example, bright portions indicating the plurality of measurement regions 61 of the teach image 60 are represented as “1” and dark portions indicating the non-measurement regions 62 serving as partitions of the measurement regions 61 are represented as “0”.

The measurement region recognizing section 52 recognizes the measurement regions 61 for each of the monochrome cameras 41 to 43 by the above-described binarization and appropriately stores the recognized measurement regions 61 in the storing section 30.

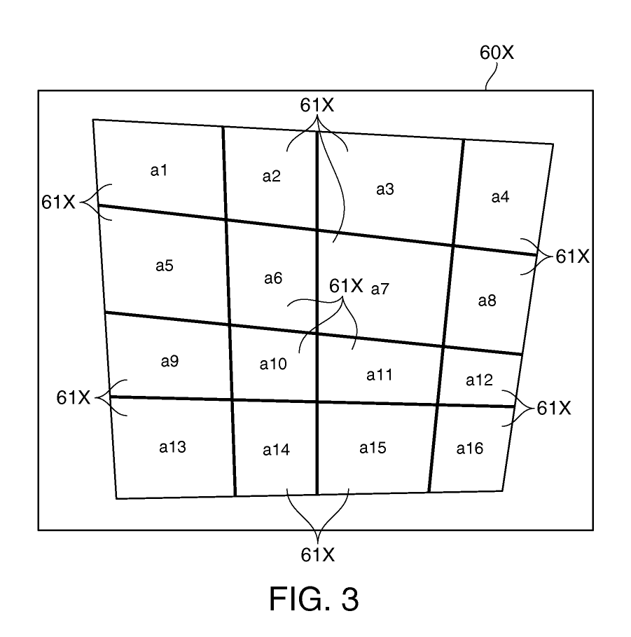

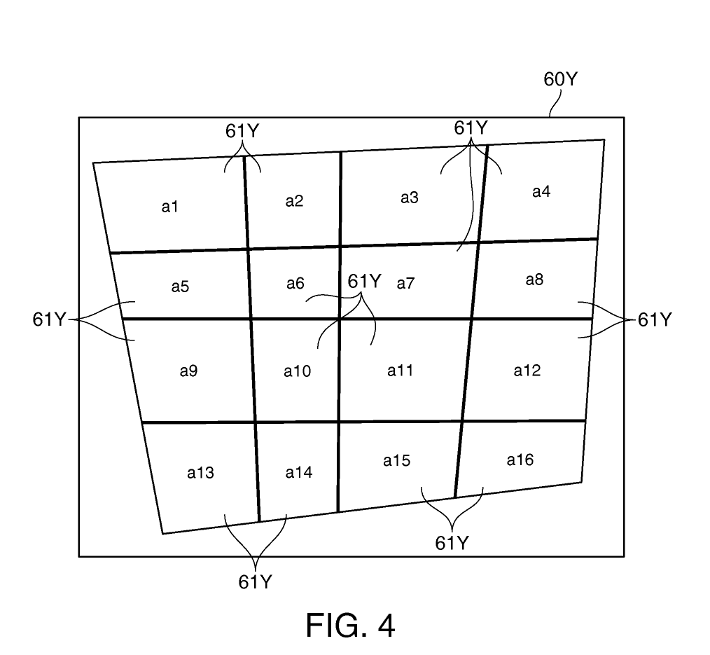

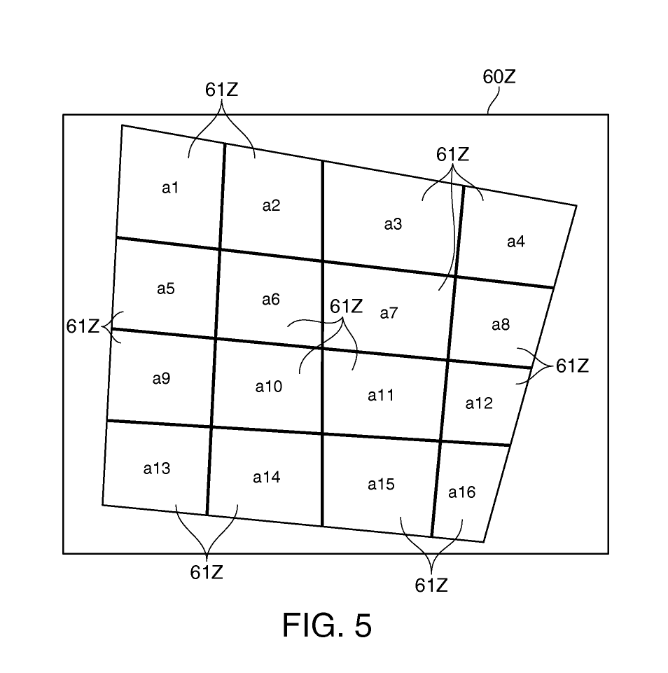

Specifically, the taken teach images obtained by taking images of the teach image 60 by the monochrome cameras 41 to 43 are distorted as shown in FIGS. 3 to 5, for example, due to the positional relationship between the monochrome cameras 41 to 43 and the display device 2. Specifically, the taken teach image obtained by the monochrome camera 41 is distorted like an X camera image 60X shown in FIG. 3. Moreover, the taken teach image obtained by the monochrome camera 42 is distorted like a Y camera image 60Y shown in FIG. 4. Furthermore, the taken teach image obtained by the monochrome camera 43 is distorted like a Z camera image 60Z shown in FIG. 5.

Incidentally, in FIGS. 3 to 5, for convenience of description, the same identification numbers a1 to a16 as those in the teach image 60 are assigned to measurement regions 61X, 61Y, and 61Z corresponding to the measurement regions 61 of the teach image 60.

As a result of these distorted X camera image 60X, Y camera image 60Y, and Z camera image 60Z being subjected to binarization, the measurement regions 61X, 61Y, and 61Z of the X camera image 60X, the Y camera image 60Y, and the Z camera image 60Z are recognized.

Under the control of the camera control section 51, the color measuring section 53 makes the monochrome cameras 41 to 43 of the image taking section 40 take images of a measurement image displayed on the display device 2, the measurement image on which color measurement is to be performed. Then, the color measuring section 53 obtains color data of each of the measured regions corresponding to the measurement regions 61X, 61Y, and 61Z recognized by the measurement region recognizing section 52 in these taken measurement images. Specifically, the color measuring section 53 obtains an average value of the brightness data of all the pixels included in each of the measured regions of the taken measurement images as a color measurement value (an X characteristic value, a Y characteristic value, and a Z characteristic value). The obtained color measurement value of each measured region is appropriately stored in the storing section 30.

More specifically, for example, a binary image of the measurement region with the identification number a1, the measurement region of the X camera image 60X, is assumed to be X(a1), and the total number of pixels in the measurement region with the identification number a1 is assumed to be Na1.

Moreover, the image data obtained by taking images of the measurement image by the monochrome cameras 41 to 43 are assumed to be X1, Y1, and Z1.

In this case, the color measuring section 53 calculates the X characteristic value of the measured region corresponding to the measurement region with the identification number a1 in the measurement image X1 by Equation (1) below.

X characteristic value of a1 region=Σ(X1∩X(a1))/Na1 (1)

That is, by obtaining the product of the measurement image X1 and the binary image X(a1) of the measurement region, the pixel data in the measured region corresponding to the measurement region with the identification number a1 in the measurement image X1 is extracted. Then, by summing the brightness values of the extracted pixel data and dividing the resultant value by the total pixel number (Na1) in the region, the average brightness value in the region is obtained as the X characteristic value.

By performing the same processing, it is possible to obtain the X characteristic value of each of the a1 to a16 regions in the measurement image X1, the Y characteristic value of each of the a1 to a16 regions in the measurement image Y1, and the Z characteristic value of each of the a1 to a16 regions in the measurement image Z1. Therefore, the X, Y, and Z characteristic values of the a1 to a16 regions are the color measurement values of these regions.

The color calibrated value calculating section 54 calculates a color calibrated value for calibrating the color measurement values calculated by the color measuring section 53. Specifically, the color calibrated value calculating section 54 calculates a color calibrated value which makes the measured color measurement values of the monochrome cameras 41 to 43 equivalent to a color reference value based on the color measurement values obtained by measuring the image displayed on the display device 2 by the monochrome cameras 41 to 43 and the color reference value obtained by measuring the image displayed on the display device 2 by a calibration reference color luminance meter 70 used as a reference colorimeter.

At this time, it is possible to perform calibration with a higher degree of accuracy by displaying the teach image 60 on the display device 2, obtaining the color measurement value of each measurement region 61 by the color measuring section 53, obtaining a color reference value by measuring each measurement region 61 with the calibration reference color luminance meter 70, and calculating the color calibrated value of each measurement region.

Specifically, the color calibrated value is calculated as a difference between the color reference value and the color measurement value (a value obtained by subtracting the color measurement value from the color reference value). The color calibrated value calculating section 54 stores this difference in the storing section 30 as the color calibrated value.

The color corrected value calculating section 55 corrects the color measurement values measured by the color measuring section 53 based on the color calibrated value calculated by the color calibrated value calculating section 54.

Specifically, the color corrected value calculating section 55 adds the color calibrated value to the color measurement value of each measured region of the measurement image, and thereby calculates a color corrected value (a calibrated color measurement value) of each measured region.

Furthermore, the color corrected value calculating section 55 stores the calculated color corrected value of each measured region in the storing section 30 as a measurement result, and outputs the calculated color corrected value as color data by performing screen display or printout. For example, the color corrected value calculating section 55 obtains the chromaticity or brightness based on the X, Y, and Z characteristic values and outputs the chromaticity or brightness as color data. Moreover, the color corrected value calculating section 55 outputs variations in the color data of each measured region as an evaluation of the color uniformity by performing screen display or printout.

The user evaluates the display device 2 based on these measurement results and adjusts the display state.

### Color Measuring Method

Next, a color measuring method using the color measuring apparatus 1 will be described based on the drawings.

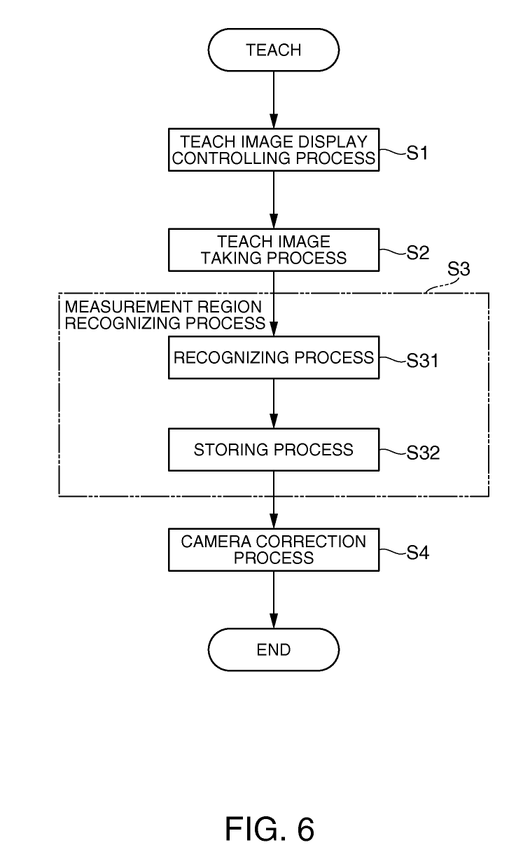

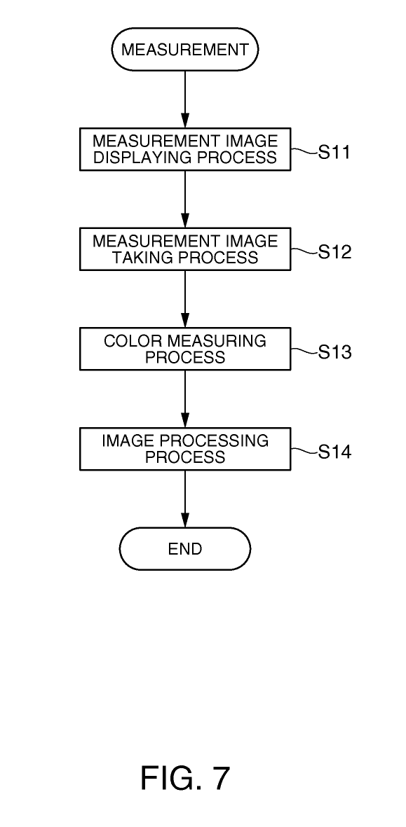

The color measuring method according to this embodiment performs measurement region setting processing for setting a measurement region shown in FIG. 6 and color measurement/correction processing shown in FIG. 7. Incidentally, when a plurality of display devices 2 are inspected, if the display devices 2 of the same type are inspected, it is necessary simply to perform the measurement region setting processing of FIG. 6 one time on the first display device 2 and then perform only the color measurement/correction processing of FIG. 7 on each of the display devices 2.

### Measurement Region Setting Processing

First, the measurement region setting processing will be described based on a flowchart of FIG. 6.

First, as advance preparation, the display device 2 is placed in a location to be measured, the location in which images of an image on the display device 2 are taken by the three monochrome cameras 41 to 43. In addition, the display device 2 is connected to the signal generating section 20 of the color measuring apparatus 1.

In this state, a teach image display controlling process S1 is first performed.

In the teach image display controlling process S1, the control section 10 reads the teach image 60 from the storing section 30, and outputs a predetermined control signal to the signal generating section 20. Then, the signal generating section 20 outputs a display control signal and thereby makes the display device 2 display the teach image 60.

Next, a teach image taking process S2 is performed. In the teach image taking process S2, the camera control section 51 controls the three monochrome cameras 41 to 43 so that the monochrome cameras 41 to 43 take images of the teach image 60 displayed on the display device 2 concurrently. As a result, the X camera image 60X, the Y camera image 60Y, and the Z camera image 60Z which are taken teach images are obtained. The X camera image 60X, the Y camera image 60Y, and the Z camera image 60Z are stored in the storing section 30.

Then, a measurement region recognizing process S3 is performed. In the measurement region recognizing process S3, image processing, for example, binarization is performed on the X camera image 60X, the Y camera image 60Y, and the Z camera image 60Z which have been obtained in the teach image taking process S2. As a result of the binarization, a recognizing process S31 in which the measurement regions 61X, 61Y, and 61Z of the X camera image 60X, the Y camera image 60Y, and the Z camera image 60Z are recognized is performed.

To the measurement regions 61X, 61Y, and 61Z recognized in the recognizing process S31, identification numbers a1, a2, . . . , a16 are sequentially assigned by labeling, from left to right and from the upper portion to the lower portion in the drawing, as shown in FIGS. 3 to 5 in the same manner as performed for the measurement regions 61 of the teach image 60.

Next, a storing process S32 in which the measurement regions 61X, 61Y, and 61Z of the X camera image 60X, the Y camera image 60Y, and the Z camera image 60Z, the measurement regions 61X, 61Y, and 61Z recognized in the recognizing process S31, are stored in the storing section 30 is performed. In this manner, the measurement regions 61X, 61Y, and 61Z are set by the monochrome cameras 41 to 43.

Next, a camera correction process S4 is performed. In the camera correction process S4, measurement data obtained by measuring the color reference value in each measurement region 61 of the teach image 60 with the calibration reference color luminance meter 70 is obtained by the color calibrated value calculating section 54 of the image processing section 50, and is stored in the storing section 30.

Then, the color calibrated value calculating section 54 measures, by the color measuring section 53, the color measurement values in the measurement regions 61X, 61Y, and 61Z of the X camera image 60X, the Y camera image 60Y, and the Z camera image 60Z of the teach image 60, the X camera image 60X, the Y camera image 60Y, and the Z camera image 60Z which have been recognized in the measurement region recognizing process S3, and stores the color measurement values in the storing section 30. The color calibrated value calculating section 54 then calculates a color calibrated value by subtracting the measured color measurement value from the color reference value which is stored in advance, and stores the color calibrated value in the storing section 30. This is the end of the camera correction process S4, and, at the same time, the measurement region setting processing is ended.

### Color Measurement/Correction Processing

Next, the color measurement/correction processing will be described based on the flowchart of FIG. 7.

In the color measurement/correction processing of this embodiment, the color of a measurement image displayed on the display device 2 is measured at multiple points, and the color uniformity of the display device 2 is evaluated.

In the color measurement/correction processing, as shown in FIG. 7, a measurement image displaying process S11 is first performed. In the measurement image displaying process S11, the display device 2 which has already been placed in position is made to display a measurement image for color measurement.

Next, a measurement image taking process S12 is performed. In the measurement image taking process S12, images of the displayed measurement image are taken by the three monochrome cameras 41 to 43 concurrently, and the taken measurement images taken by the monochrome cameras 41 to 43 are obtained. The taken measurement images are stored in the storing section 30.

Next, a color measuring process S13 is performed. In the color measuring process S13, image data of measured regions corresponding to the measurement regions 61X, 61Y, and 61Z in the taken measurement images obtained in the measurement image taking process S12 is extracted, and color measurement values including an X characteristic value, a Y characteristic value, and a Z characteristic value of the measured regions are calculated by Equation (1) above.

Next, an image processing process S14 is performed. In the image processing process S14, the color corrected value calculating section 55 calculates a color corrected value by adding the color calibrated value obtained in the camera correction process S4 to each of the color measurement values of the measured regions obtained in the color measuring process S13.

Furthermore, the color corrected value calculating section 55 stores the calculated color corrected values of the measured regions in the storing section 30 as the measurement result, and outputs the color corrected values as color data such as chromaticity or brightness by performing screen display or printout. Moreover, the color corrected value calculating section 55 outputs variations in the color data of each measured region as an evaluation of the color uniformity by performing screen display or printout.

This is the end of the color measurement/correction processing performed on the first display device 2. When a display device 2 of the same model is inspected without a break, it is necessary simply to repeat only the color measurement/correction processing of FIG. 7.

On the other hand, when a display device 2 of a different model is inspected, it is necessary simply to perform the processing again from the measurement region setting processing of FIG. 6 because a change in the size etc. of the display device 2 results in a change in distortion of images taken by the monochrome cameras 41 to 43 and a change in the measurement regions 61X, 61Y, and 61Z.

### Effect of the Embodiment

As described above, in the embodiment described above, a teach image 60 showing a plurality of measurement regions 61 with a certain degree of chromaticity or brightness and non-measurement regions with a different degree of chromaticity or brightness, the non-measurement regions other than the measurement regions, is displayed on the display device 2, images thereof are taken, and image processing is performed on the images, whereby measurement regions 61 are recognized. Then, a measurement image is displayed on the display device 2 and an image thereof is taken, and the colors of the measured regions in the taken measurement image, the measured regions corresponding to the recognized measurement regions 61, are measured.

This eliminates the need for input operation performed by the user for setting measured regions in a measurement image, and makes it possible to set, automatically and with a high degree of accuracy, measured regions for performing multipoint measurement on a measurement image displayed on the display device 2. As a result, it is possible to perform measured region setting operation with ease and in a short time. In addition, since a point or a region on which the user desires to perform measurement can be set by just generating a teach image 60 in which measurement regions 61 are drawn with a certain degree of chromaticity or brightness and non-measurement regions 62 are drawn with a different degree of chromaticity or brightness, it is possible to change the measurement regions 61 easily.

Moreover, in this embodiment, since images are taken by the three monochrome cameras 41 to 43 concurrently, there is no need to perform image scan operations sequentially in individual display colors. This makes it possible to shorten the amount of time. Furthermore, it is possible to prevent an increase in measuring time as a result of measurement being performed in individual display colors for one second or more in order to prevent the influence of flicker. As described above, since three tristimulus filters, i.e., the X filter 44X, the Y filter 44Y, and the Z filter 44Z are provided in the three monochrome cameras 41 to 43, respectively, the inexpensive monochrome cameras 41 to 43 can be used also in color measurement, and it is also possible to shorten the measuring time.

In addition, a color corrected value is calculated by calibrating (correcting) the color measurement value of each measured region by using the color calibrated value based on the color reference value obtained by measurement by the calibration reference color luminance meter 70. This makes it possible to obtain a more accurate color measurement value as compared to a case in which no calibration is performed by using a color calibrated value. Moreover, it is necessary simply to perform calculation of a color calibrated value by using the calibration reference color luminance meter 70 only one time, and then the color can be measured only by taking images by the monochrome cameras 41 to 43. As a result, the measuring time can also be shortened as compared to a case in which measurement is performed only by the calibration reference color luminance meter 70.

### Modified Examples of the Embodiment

It is to be understood that the invention is not limited in any way by the embodiment thereof described above, and, unless modifications and variations depart from the scope of the invention, they should be construed as being included therein.

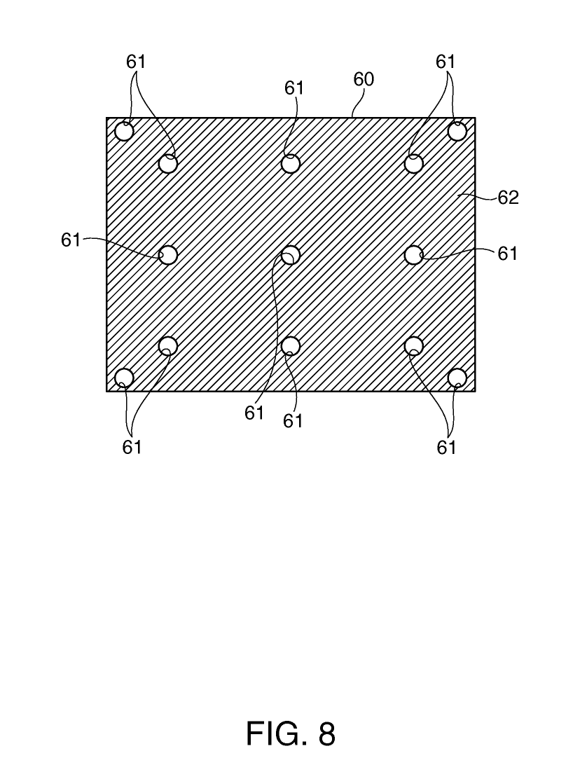

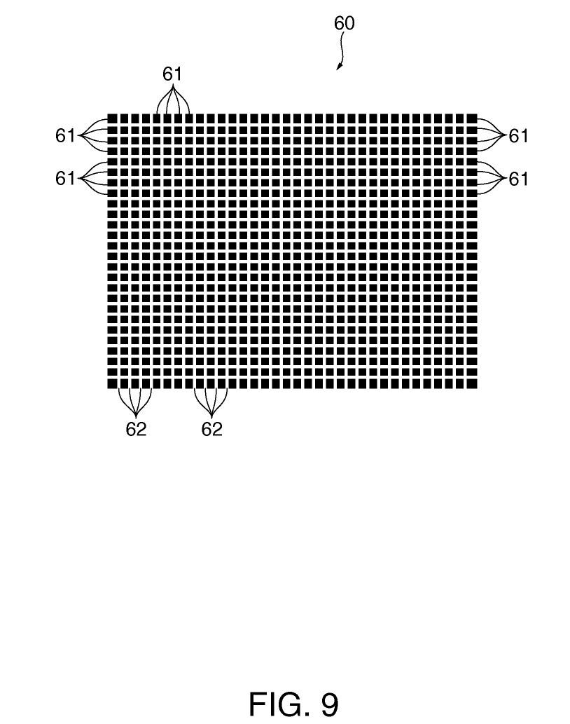

That is, the descriptions heretofore deal with the teach image 60 divided into 16 parts, the teach image shown in FIG. 2; however, the measurement regions are not limited to grid-like 16 measurement regions. For example, as shown in FIG. 8, 13 circular regions may be measured as measurement regions 61 by using a teach image 60 which is a measurement point image defined by the ANSI (American National Standards Institute) 215-1992. Furthermore, as shown in FIG. 9, for example, a teach image 60 showing measurement regions 61 obtained by dividing the teach image 60 into 884 small portions in a grid-like pattern may be used. Incidentally, in FIG. 9, the measurement region 61 is shown as a black part, and the non-measurement region 62 is shown as a white part. As described above, various types and forms of teach images 60 appropriately showing, as a point or a region, a measurement region 61 on which the user desires to perform measurement can be used.

Moreover, the descriptions heretofore deal with binarization as image processing; however, the image processing is not limited thereto. It is possible to adopt various types of image processing by which a measurement region with at least chromaticity or brightness which is different from that of a region to be measured can be recognized.

In addition, the descriptions heretofore deal with the three monochrome cameras 41 to 43 as the image taking section 40, the monochrome cameras 41 to 43 which are provided with three tristimulus filters, i.e., the X filter 44X, the Y filter 44Y, and the Z filter 44Z, respectively; however, the configuration is not limited thereto. For example, a taken image may be obtained by taking an image of a teach image 60 or a measurement image by using one color camera.

Moreover, in the embodiment described above, the camera correction process S4 is performed in the measurement region setting processing shown in FIG. 6, and the image processing process S14 for calibrating the color measurement value is performed in the color measurement/correction processing shown in FIG. 7. However, an evaluation etc. of the color uniformity may be performed based on the color measurement value measured in the color measuring process S13 without calculating a color calibrated value.

Furthermore, in the embodiment described above, a color calibrated value is calculated by performing the camera correction process S4 in the measurement region setting processing shown in FIG. 6. However, for example, a color calibrated value may be calculated in the color measurement/correction processing performed on the first display device 2.

In addition, the descriptions heretofore deal with a configuration in which the signal generating section 20 is provided, a signal is transmitted from the signal generating section 20 to the display device 2, and a teach image 60 is displayed on the display device 2; however, the configuration is not limited thereto.

For example, when the built-in OSD 2A and the switching section 2B are provided in the display device 2, a teach image or a measurement image may be displayed by the built-in OSD 2A by switching performed by the switching section 2B.

Furthermore, when the built-in OSD 2A is provided in the display device 2, the signal generating section 20 may by omitted, and a teach image or a measurement image may be displayed on the display device 2 by the built-in OSD 2A.

The entire disclosure of Japanese Patent Application No. 2010-090160, filed Apr. 9, 2010 is expressly incorporated by reference herein.

What is claimed is:

1. A color measuring apparatus comprising:
an image taking section taking an image of an image displayed on a display device;
an image display control section selecting a teach image in which a plurality of measurement regions are set or a measurement image for color measurement and making the display device display the selected image;
a camera control section controlling the image taking section to make the image taking section take an image of the image displayed on the display device;
a measurement region recognizing section recognizing the measurement regions by performing image processing on the teach image whose image was taken by the image taking section; and
a color measuring section measuring the color of each of measured regions corresponding to the measurement regions recognized by the measurement region recognizing section, the measured regions in the measurement image whose image was taken by the image taking section,
wherein
in the teach image, the plurality of measurement regions are shown with a certain degree of chromaticity or brightness and non-measurement regions other than the measurement regions are shown with a different degree of chromaticity or brightness, and
the measurement region recognizing section recognizes the measurement regions by performing image processing on the teach image whose image was taken by the image taking section based on the difference in degree of chromaticity or brightness between the measurement regions and the non-measurement regions.

2. The color measuring apparatus according to claim 1, wherein
the image taking section includes three cameras which take images of the image displayed on the display device and three tristimulus filters provided in the three cameras, the tristimulus filters provided one for each of the three cameras,
the camera control section performs control such that images of the image displayed on the display device are taken by the cameras concurrently,
the measurement region recognizing section recognizes the measurement regions by performing image processing on the images of the teach image, the images taken by the cameras, and
the color measuring section measures the colors of measured regions corresponding to the measurement regions recognized by the measurement region recognizing section, the measured regions in measurement images whose images were taken by the cameras.

3. The color measuring apparatus according to claim 1, further comprising:
a color calibrated value calculating section calculating a color calibrated value based on a measurement value of the color of each measured region, the measurement value of the color measured by the color measuring section, and a color reference value obtained by measuring each measured region of the measurement image by a reference colorimeter; and
a color corrected value calculating section calculating a color corrected value by correcting the measurement value measured by the color measuring section based on the color calibrated value calculated by the color calibrated value calculating section.

4. A color measuring method, comprising:
a teach image display controlling process in which a teach image is displayed on a display device, the teach image including a plurality of measurement regions shown with a certain degree of chromaticity or brightness and non-measurement regions shown with a different degree of chromaticity or brightness;
a teach image taking process in which a taken teach image is obtained by taking, by an image taking section, an image of the teach image displayed on the display device in the teach image display controlling process;
a measurement region recognizing process in which the measurement regions are recognized by performing image processing on the taken teach image obtained in the teach image taking process based on the difference in degree of chromaticity or brightness between the measurement regions and the non-measurement regions;
a measurement image displaying process in which a measurement image is displayed on the display device;
a measurement image taking process in which a taken measurement image is obtained by taking an image of the measurement image by the image taking section, the measurement image displayed in the measurement image displaying process; and
a color measuring process in which the color of each of measured regions corresponding to the measurement regions recognized in the measurement region recognizing process, the measured regions in the taken measurement image obtained in the measurement image taking process.
